(19) United States
(12) Patent Application Publication
(10) Pub. No.: US 2006/0079999 A1
(43) Pub. Date: Apr. 13, 2006

(54) Building management with remote configuration

(76) Inventor: Sajed Husein, London (GB)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 10/541,711

(22) PCT Filed: Dec. 29, 2003
(86) PCT No.: PCT/GB03/05705

§ 371 Date: Jul. 8, 2005

(30) Foreign Application Priority Data
Jan. 9, 2003 (GB) 0300499.1

(51) Int. Cl. G01M 1/38; G05B 13/00; G05B 15/00; G05B 21/00; G05D 23/00

(52) U.S. Cl. 700/275

(57) ABSTRACT

A building management system and method for configuring the same are disclosed, the building management system comprising a front end device networked to a plurality controller devices. Each controller devices is adapted to transmit a configuration data request if not sufficiently configured to perform its appointed role and the front-end device is adapted to respond to such a configuration data request by broadcasting a configuration data response containing the required configuration data to all the controller devices. Each broadcast configuration data response further includes sufficient information to enable each controller device to determine whether to act on or ignore the broadcast configuration data response

The present invention relates to a novel Building Management System and method for the configuration thereof.

Building Management Systems (BMS) are used to perform environmental control and energy management functions within commercial buildings and factories, and may exercise control over a variety of factors ranging from the mundane (eg. room temperature, room humidity) to the critical (eg. manufacturing parameters, security, life support and so on). They typically comprise embedded devices known as controller devices (or simply controllers), which perform data acquisition and some form of control and reporting activities. These controllers are networked together using a communications system with a front-end device (for example a personal computer or other suitable type of data processor) as a means of providing a user interface to the system.

The communications system used in BMS has traditionally been based on proprietary architecture. However, within the past few years, an increasing number of BMS manufacturers have embraced industry standard communication architectures such as those used in standard IT (Information Technology) and office based systems. This has enabled the manufacturer to take advantage of industry standard techniques that are prevalent in such systems.

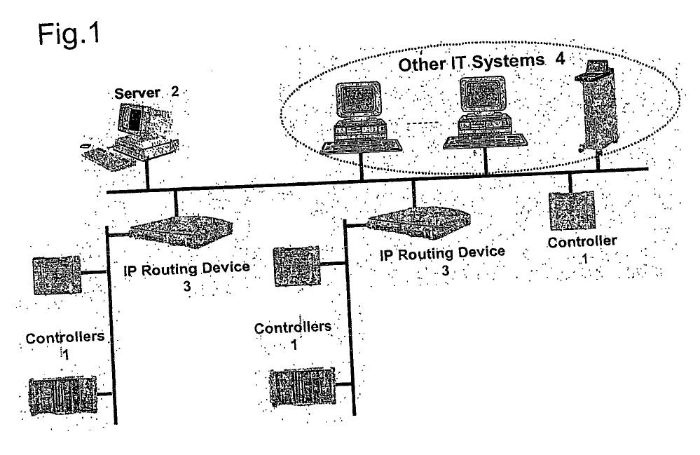

One of the major challenges faced by the installers of BMS is to be able to perform fast and accurate system configuration; this is especially critical when the system consists of a large number of controllers (>20). Typically, system configuration is a two-stage process; the first stage requires the installer/engineer to manually enter data (including at least a device number and Internet Protocol (IP) address) into each controller using a dumb terminal or a laptop PC. The second stage involves the downloading of the complete configuration data from the front-end device. This process, however, can lead to a number of potential problems, as will be explained below in greater detail, with reference to FIG. 1.

FIG. 1 shows, in outline, the network layout of a standard Building Management System. The system comprises a plurality of controllers 1 and a server 2 (normally a PC, which operates as the front-end device). One or more routing devices 3 (routers) are used to create a hierarchical network layout, whereby the server 2 “sits” on the backbone network and the controllers 1 are clustered on one or more sub-networks. Both the controllers 1 and the server 2 use IP technology (IP addressing and routing), which allows standard “off-the-shelf” IP routing devices to be used as the routers 3. In some cases the network may also be utilised by other IT systems 4.

The system is based on a distributed architecture whereby the controllers 1 are highly intelligent in that they can perform complex control functions. Once set-up, the controllers 1 are fully capable of operating without any user intervention and do not necessarily require the use of a front-end application running on the server 2. This is achieved by a thorough configuration of the controllers 1 during installation stage.

The installation of the system involves the following stages:
1. The installer lays-out the communication lines (or uses existing ones if appropriate) and powers-up the controllers; this ensures that each controller is operational. At this stage, the controller is in a “non-commissioned” state. Once this process is complete, the installer then hands over the site to the commissioning engineer.
2. The commissioning engineer partially configures each controller on-site (using a hand-held device e.g., terminal or a notebook PC), by giving each controller a unique device identifier and an IP address. The controllers remain in their un-commissioned state, although it is now possible to communicate with the devices given that each has an IP address.
3. On the server, the engineer defines each controller by specifying its device identifier and IP addresses and inputting additional configuration data such as control algorithms, cross-references and/or other parameters.
4. The final stage involves the manual download of the configuration data input at step 4 to each of the controllers. Each controller, upon receiving the data, performs a reset and restarts with the new parameters—the controller will then be in a “commissioned” state.

Once all the controllers on the site have been commissioned, the BMS system can then operate normally.

However, setting up a BMS in the manner described above can suffer from a number of potentially very serious drawbacks. A typical medium sized BMS site can have around 40+ controllers, but in most cases BMS projects involve large buildings where the number of controllers can reach the 100s. One of the largest BMS sites currently in operation has 520 controllers and current predictions indicate that this will become a typical figure for future BMS sites.

In a medium sized site (with 40+ controllers) the above configuration process can be long and tedious; typically the configuration time is in the order of about 5-10 minutes per controller, which translates into about 4 hours of configuration time. This overhead can have major implication on project costs as well as the time to complete the site configuration.

Furthermore, where a commissioning process involves different stages of configuration, there exists a high probability that an engineer could inadvertently make mistakes. The configuration process involves entering a number of system parameters such as Device Identifier, IP addresses, Default & Backup Server information. In particular, errors may be caused by having to manually enter IP address configuration, such as typographical errors and/or address conflicts caused by a currently assigned IP address accidentally being reissued to another controller.

In some cases, the error may be such that the controller may appear to the commissioning engineer as being fully operational even though wrong parameters were accidentally used. Here the mistakes are not detected until the site is up and running. This can often lead to a dangerous situation when the controllers are geared towards managing complex plants and machinery.

It will be apparent from the above that the current configuration process provides a good deal of scope for error during configuration stage. This, together with the actual time required to set-up the site, can lead to unexpected delays and costs.

One possible alternative to using the current configuration process would be to make use of the Dynamic Host Configuration Protocol (DHCP) to partly automate the process.

Dynamic Host Configuration Protocol (DHCP) is a standard protocol defined by RFC (Request For Comment) 1541 (which is superseded by RFC 2131) that allows a server to dynamically distribute IP addressing and configuration information to clients (remote terminals) over a network. Normally the DHCP server provides the client with at least the following basic information—IP Address, Subnet Mask and Default Gateway.

Other information can be provided as well, such as Domain Name Service (DNS) server addresses and Windows Internet Name Service (WINS) server addresses. The system administrator configures the DHCP server with the options that are to be parsed out to each client.

Dynamic Host Configuration Protocol was derived from the Internet standard Bootstrap Protocol (BOOTP) (RFCs 951 and 1084), which allowed dynamic assignment of IP addresses (as well as remote booting of diskless workstations). In addition to supporting dynamic assignment of IP addresses, DHCP supplies all configuration data required by TCP/IP, plus additional data required for specific servers.

As will be explained in greater detail below, the DHCP potentially allows the network administrator to configure a plurality of client terminals by manually configuring just one machine—the DHCP server. Whenever a new host is plugged into the network segment that is served by the DHCP server (or an existing host is turned back on), the machine asks for a unique IP address, and the DHCP server assigns it one from the pool of available IP addresses.

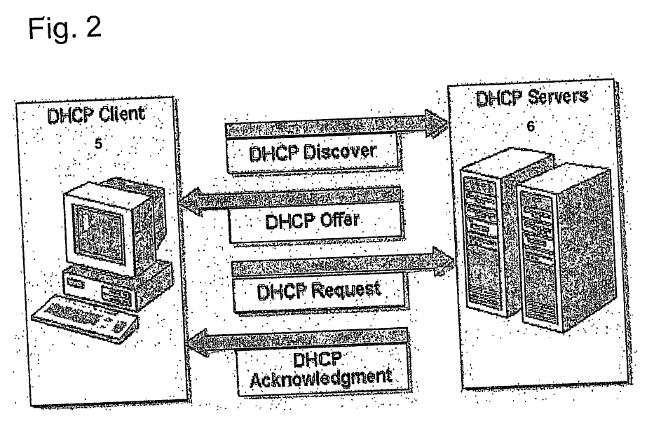

The DHCP client configuration process, as shown in FIG. 2, involves just four steps: The DHCP client 5 asks for an IP address (DHCP Discover), is offered an address (DHCP Offer) by the DHCP server 6, accepts the offer and requests the address (DHCP Request), and is officially assigned to the address (DHCP Acknowledge).

To make sure addresses are not wasted, the DHCP server 6 places an administrator defined time limit on the address assignment, called a lease. Halfway through the lease period, the DHCP client 5 requests a lease renewal, and the DHCP server 6 extends the lease. This means that when a machine stops using its assigned IP address (for example, on being moved to another network segment or being retired), the lease expires, and the address is returned to the pool for reassignment.

Deploying DHCP on enterprise networks therefore provides the following benefits:
1. Safe and reliable network configuration;
   a. DHCP minimises configuration errors caused by manual IP address configuration, such as typographical errors;
   b. DHCP minimises address conflicts caused by a currently assigned IP address accidentally being reissued to another computer;
2. Reduced network administration;
   a. TCP/IP configuration is centralized and automated;
   b. network administrators can centrally define global and subnet-specific TCP/IP configurations;
   c. clients can be automatically assigned a full range of additional TCP/IP configuration values by using DHCP options;
   d. address changes for client configurations that must be updated frequently, such as remote access clients that move around constantly, can be made efficiently and automatically when the client restarts in its new location; and
   e. most routers can forward DHCP configuration requests, eliminating the requirement of setting up a DHCP server on every subnet, unless there is another reason to do so.

As a result DHCP and its associated components form a powerful and indispensable tool within the IT industry. It is a key component of the TCP/IP suite and widely accepted as a major industry standard. However, despite this fact, using DHCP also presents a number of challenges and shortcomings when applied to the Building Management Systems.

A underlying principle of DHCP is that it relies on allocating IP addresses on a first-come-first-serve basis—ie. the IP addresses are dynamically allocated. It is therefore inherent in a DHCP system that a DHCP client is not guaranteed the same IP address every time it re-joins the network, and consequently a typical service or application cannot rely on IP addresses alone to access information. This, in the IT industry, is resolved by using a naming convention (supported by the Domain Name Service, or DNS for short) in which each device is known by its unique name; the underlying services translate the name into an IP address that has been allocated by the DHCP server.

Within a BMS application, applications also refer to other applications or services using a naming convention with the underlying functions translating device names into their respective IP addresses. However, with any real-time closed loop control system, the use of dynamically allocated IP addresses presents a number of problems. It is not uncommon for Controllers to perform automatic resets, known as Warm Resets, which unlike Cold Resets preserve existing control parameters (other than the IP address) and ensure that the system carries on functioning in the manner it did before the reset. If the IP address and other information were obtained dynamically, the warm reset together with other actions that the Controller may take will require the use of the DHCP services. Whilst this may be acceptable, the reliance on a DHCP server does raise the issue of the DHCP server becoming a single point of failure i.e., loss of the server will mean that parts of the BMS are unable to communicate and be controlled normally. The consequence of this could be quite catastrophic in some cases. The need for a reliable and deterministic control system such as the BMS dictates for statically allocated parameters that are guaranteed not to change during the operation of the system.

Also, a number of BMS consist of controllers that work in physically & geographically isolated locations. These controllers often use a dial-up mechanism to send information to the BMS Server as well as to other controllers in other locations. The use of a dial-up mechanism means that the DHCP cannot be used as primary means of configuring these controllers.

As is apparent from the above, while the DHCP is commonly used within an IT environment, it is unlikely in most circumstances to adequately address the needs of the Building Systems & controls industry.

According to one aspect of the present invention, a building management system is provided comprising a front end device networked to a plurality of controller devices, each controller device being adapted to transmit a configuration data request if not sufficiently configured to perform its appointed role and the front-end device being adapted to respond to such a configuration data request by broadcasting a configuration data response containing the required configuration data to all the controller devices, each broadcast configuration data response including sufficient information to enable each controller device to determine whether to act on or ignore the broadcast configuration data response.

According to another aspect of the present invention, a method of configuring a building management system comprising a front end device networked to a plurality of controller devices is provided, the method comprising:
a) programming each controller device to check whether or not it has sufficient configuration data to perform its appointed role and, if not, to transmit a configuration data request; and
b) programming the front end device to respond to a configuration data request from a controller device by broadcasting a configuration data response to all the controller devices, each such configuration data response comprising the configuration data required by the controller device that transmitted the configuration data request and sufficient information to enable each controller device to determine whether to act on or ignore the configuration data response.

Preferably, the configuration data responses are IP multicast transmissions, the controller devices all sharing the same IP multicast address.

Each configuration data response may include a controller device identifier identifying the controller device that requires the configuration data, each controller device being adapted to act only on a configuration data response containing its respective controller device identifier.

Each configuration data request may include a controller device identifier identifying the controller device sending the configuration data request, the front end device being adapted to check the controller device identifier in any incoming configuration data request in order to determine the configuration data required.

Preferably, each controller device is adapted to broadcast a configuration data request to all the other controller devices and the front end device, each such configuration data request including sufficient information to enable each device receiving it to determine whether to act on or ignore the configuration data request. Where this is the case, the configuration data requests are preferably IP multicast transmissions, the front end device and controller devices all sharing the same IP multicast address.

Each configuration data request and each configuration data response may include a transmission type identifier identifying the transmission type as a request or response, the controller devices being adapted to act only on responses and the front end device being adapted to act only on requests.

Each controller device may be adapted to check on power-up whether or not it has sufficient configuration data to perform its appointed role.

Each controller device may be adapted to retain, once configured, its configuration data in the event of a restart.

Each controller device may be adapted to re-transmit a configuration data request if it has not received an acceptable configuration data response within a predetermined interval.

As explained above, in a conventional BMS, each data transmission is directed towards one or more specific recipients each identified by a unique IP address (such transmissions sometimes being referred to as IP unicasting or point-to-point messaging). However, in the present invention, each configuration data response is broadcast such that it is transmitted to all the controllers, the contents of the transmission or broadcast itself enabling each controller to determine whether or not the transmission is of relevance to it. Likewise, configuration data requests from the controllers are preferably similarly broadcast.

As noted, a preferred method of ensuring that each configuration data request and response are directed to all the controllers and the server is to make use of IP multicast transmissions. In IP multicasting, each device in a specified group is assigned the same IP address (a so-called multicast address) and any transmission sent to this address is routed by multicast routers to each device in that group. Thus the transmission concerned is in essence broadcast to a specified set or group of devices. This is in general to be preferred to forms of IP broadcasting in which each data transmission is sent to any and every device connected to a network, so as to avoid erroneously transmitting configuration data responses or requests to third party devices that may be present on the network—ie. by assigning the multicast address only to the front end device and the controllers, the BMS transmissions can be isolated from any other unrelated devices/hardware that may be sharing the same IP network.

An embodiment of the invention will now be described, by way of example, with reference to the accompanying Figures, in which:

FIG. 1 is a schematic showing, in outline, the network layout of a standard Building Management System (prior art);

FIG. 2 is a schematic illustrating the DHCP client configuration process (prior art);

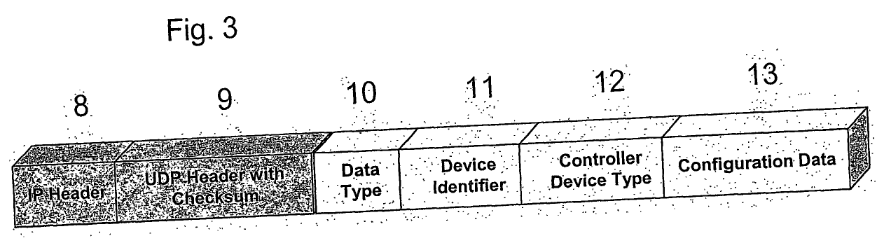

FIG. 3 is a schematic illustrating an Internet Protocol & UDP payload data transmission;

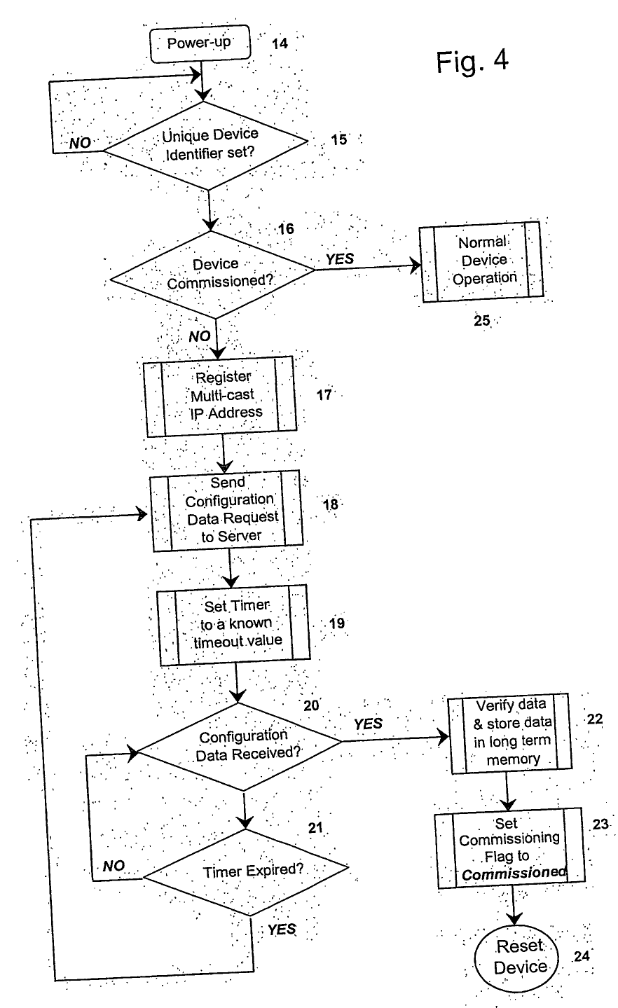

FIG. 4 is a flow chart of a Controller configuration process in accordance with the present invention, from the perspective of a Controller; and

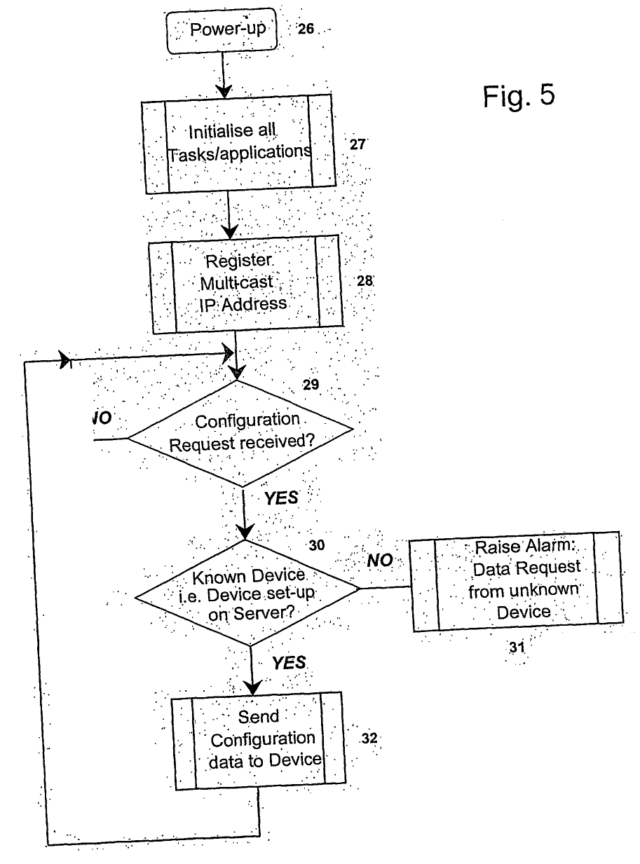

FIG. 5 is a flow chart of the configuration process of FIG. 4, from the perspective of the Server.

A Building Management System according to the present embodiment of the invention comprises a conventional network layout as described above in relation to FIG. 1, ie. the system comprises a plurality of controllers 1 connected to a server 2 via one or more routers 3 so as to form a hierarchical network layout, with the server 2 connected to the backbone network and the controllers 1 clustered on one or more sub-networks.

The controllers 1 store all configuration data in long-term memory such as battery-backed RAM or EEPROM or FLASH memory devices and that all devices, prior to configuration, will have all configuration parameters set to zero or a known value. Every controller also maintains a flag, known as the Commissioning Flag, in its long-term memory. This flag is initialised to a “non-commissioned” state prior to the controller receiving its configuration data. Prior to its configuration, each controller is also assigned a unique device identifier which is hard coded or stored in its long term memory.

In order to make use of IP multicasting, the server 2 (there may be more than one) is required to register a multi-cast IP address, which currently lie in the range 224.0.0.0 through to 239.255.255.255, at all times. This allows the server 2 to receive data that is transmitted using the multi-cast address. All intermediate routers 3 are adapted to forward data addressed using this multi-cast address.

Referring now to FIG. 3, the configuration data transmissions from the controllers and the server are encapsulated within an IP & UDP (User Datagram Protocol) payloads. These payloads comprise an IP header 7 and a UPD header 8. The UDP header 8 has a checksum option and it is recommended that this option be enabled so that the integrity of all data transfers can be maintained.

In addition to the IP and UDP headers 7, 8, each transmission also comprises the following data fields:
a) a Data Type field 9 containing data that indicates whether the transmission is a “configuration data request” (which identifies the transmission as originating from a controller requiring configuration data) or a “configuration data response” (which identifies the transmission as a response originating from the server);
b) a Device Identifier field 10 containing the unique device identifier of the controller that requires configuration data;
c) in the case of a typical BMS site, comprising different controller types (in the sense of having different functions and/or roles), a Controller Device Type field 11 containing data that indicates the type of controller that requires configuration data; and
d) a Configuration Data field 12—where the data transmission is a configuration request (ie. it originates from a controller requiring configuration data) no data will be contained in this field, however, where the data transmission is a configuration data response (ie. a response from the Server to a configuration request) this field will contain the required configuration data for the controller in question.

Referring now to the controller flow chart of FIG. 4, upon power-up 14 a controller decides if it needs to request for configuration data from the server. This request is only made if the controller's checks indicate that it has been given a unique identifier (check 15) and is in non-commissioned state (check 16).

The controller registers 17 the pre-determined multicast IP address—this allows the controller to send data to all devices using the IP address. It then sends a configuration request 18 to the server and since the Data Type is set to Request, all other controllers will ignore this data packet.

The controller then sets a timer 19 and awaits a response from the server. If the timer expires (check 21) before the response is received (check 20), a new configuration request 18 is dispatched. Once a response is received from the server, the controller verifies the data 22 and updates the configuration area within its long-term memory. It also sets the Commissioning Flag to “commissioned” state 23, thus ensuring that no further requests are sent to the server. The controller then performs a reset 24 and starts-up with the new configuration parameters—upon restart, the controller does not need to re-register the multicast IP address, but instead proceeds to normal operation of the device 25.

Referring now to the server flow chart of FIG. 5, once the server has been powered up 26, initialised all tasks and applications 27, and registered 28 the multicast IP address, the server waits 29 for any in-coming Configuration Request packet. Once received, it verifies 30 the Controller Identifier and Type against a locally stored database of controller configuration. If the Server does not recognise the device, it will generate an alarm 31 so that the operator can take appropriate action, otherwise it will send 32 the required configuration data to the device using the multicast IP address. Since the IP data packet contains a field identifying the Controller by its unique identifier, all other Controllers will ignore this data packet.

A comparison of the known method of configuring a BMS, as described above, with the configuration method described in relation to the present embodiment, is shown below in Table 1. As is apparent therefrom, in the present embodiment the configuration process is simplified, when compared to a standard BMS and configuration process, thus saving time and cost of installation and reducing the chances of errors occurring during configuration process.

The technique described here is not confined to one specific BMS but instead can be used with any BMS that is based on IP technology.

The foregoing broadly describes the present invention, without limitation. Variations and modifications as would be apparent to those of ordinary skill in the art are intended to be comprised within the scope of this application and subsequent patent(s).

TABLE 1

| | | USING METHOD OF |
|---|---|---|
| STAGE | USING KNOWN METHOD | PRESENT EMBODIMENT. |
| 1 | The installer lays-out the | Same as before. |
| | communication medium (or | |
| | uses existing ones if | |
| | appropriate) and powers-up | |
| | the Controllers; this | |
| | ensures that the Controller | |
| | is operational. | |
| 2 | The commissioning engineer | Only a unique device id |
| | partially configures each | need be provided. |
| | Controller on-site by pro- | |
| | viding a device id and | |
| | unique IP address. | |
| 3 | On the front-end device, the | Only the device id need be |
| | set-up application requires | specified, with the addi- |
| | the engineer to define each | tional configuration data |
| | Controller by specifying its | being input as before - |
| | device id and IP address and | in both cases, the set-up |
| | inputting the appropriate | application may validate |
| | additional configuration | the additional configura- |
| | data. | tion data. |
| 4 | The additional input config- | The additional configura- |
| | uration data is downloaded | tion data for each control- |
| | individually to each of the | ler is broadcast as a |
| | Controllers using the | multi-cast transmission |
| | specified IP addresses. Each | containing the specified |
| | Controller, upon receiving | device id. Each controller |
| | the additional data, performs | determines which transmis- |
| | a reset and restarts with the | sion is appropriate to it |
| | new parameters. | and performs a reset and |
| | | restart as before. |

1. A building management system comprising a front end device networked to a plurality of controller devices, each controller device being adapted to transmit a configuration data request if not sufficiently configured to perform its appointed role and the front-end device being adapted to respond to such a configuration data request by broadcasting a configuration data response containing the required configuration data to all the controller devices, each broadcast configuration data response including sufficient information to enable each controller device to determine whether to act on or ignore the broadcast configuration data response.

2. A building management system according to claim 1, wherein the configuration data responses are IP multicast transmissions, the controller devices all sharing the same IP multicast address.

3. A building management system according to claim 1, wherein each configuration data response includes a controller device identifier identifying the controller device that requires the configuration data, each controller device being adapted to act only on a configuration data response containing its respective controller device identifier.

4. A building management system according to claim 1, wherein each configuration data request includes a controller device identifier identifying the controller device sending the configuration data request, the front end device being adapted to check the controller device identifier in any incoming configuration data request in order to determine the configuration data required.

5. A building management system according to claim 1, wherein each controller device is adapted to broadcast a configuration data request to all the other controller devices and the front end device, each such configuration data request including sufficient information to enable each device receiving it to determine whether to act on or ignore the configuration data request.

6. A building management system according to claim 5, wherein the configuration data requests are IP multicast transmissions, the front end device and controller devices all sharing the same IP-multicast address.

7. A building management system according to claim 5, wherein each configuration data request and each configuration data response includes a transmission type identifier identifying the transmission type response, the controller devices being adapted to act only on responses and the front end device being adapted to act only on requests.

8. A building management system according to claim 1, wherein each controller device is adapted to check on power-up whether or not it has sufficient configuration data to perform its appointed role.

9. A building management system according to claim 1, wherein each controller device is adapted to retain, once configured, its configuration data in the event of a restart.

10. A building management system according to claim 1, wherein each controller device is adapted to re-transmit a configuration data request if it has not received an acceptable configuration data response within a predetermined interval.

11. A method of configuring a building management system comprising a front end device networked to a plurality of controller devices, the method comprising:
a. programming each controller device to check whether or not it has sufficient configuration data to perform its appointed role and, if not, to transmit a configuration data request; and
b. programming the front end device to respond to a configuration data request from a controller device by broadcasting a configuration data response to all the controller devices, each such configuration data response comprising the configuration data required by the controller device that transmitted the configuration data request and sufficient information to enable each controller device to determine whether to act on or ignore the configuration data response.

12. A method according to claim 11, comprising programming the front end device to send configuration data responses using an IP multicast address registered or to be registered by the controller devices.

13. A method according to claim 11, comprising programming the front end device to include a controller device identifier identifying the controller device that requires the configuration data in each configuration data response and programming each controller device to act only on a configuration data response comprising its respective controller device identifier.

14. A method according to claim 11, comprising programming each controller device to include in each data request it sends a controller device identifier identifying itself and programming the front end device to check the controller device identifier in any incoming configuration data request in order to determine the configuration data required.

15. A method according to claim 11, comprising programming each controller device to broadcast a configuration data request to all the other controller devices and the front end device, each such configuration data request including sufficient information to enable each device receiving it to determine whether to act on or ignore the configuration data request.

16. A method according to claim 15, comprising programming the controller devices to send configuration data requests using an IP multicast address registered or to be registered by all the controller devices and the front end device.

17. A method according to claim 15, comprising programming the controller devices and front end device to include a transmission type identifier in any configuration data request or configuration data response being sent identifying the transmission type as a request or response and programming the controller devices to act only on responses and the front end device to act only on requests.

18. A method according to claim 11, comprising programming each controller device to check on power up whether or not it has sufficient configuration data to perform its appointed role.

19. A method according to claim 11, comprising programming each controller device to retain, once configured, its configuration data in the event of a restart.

20. A method according to claim 11, comprising programming each controller device to re-transmit a configuration data request if it has not received an acceptable configuration data response within a predetermined interval.

21. (canceled)

22. (canceled)
